(19) United States
(12) Patent Application Publication
(10) Pub. No.: US 2012/0162751 A1
(43) Pub. Date: Jun. 28, 2012

(54) OPTICAL COATING FOR ELECTRONIC DEVICE DISPLAY

(75) Inventors: Frank F. Liang, San Jose, CA (US); Phillip L. Mort, Santa Clara, CA (US); Amaury J. Heresztyn, Cupertino, CA (US); Jay S. Nigen, Mountain View, CA (US); Simon Prakash, Los Gatos, CA (US); John P. Ternus, Redwood City, CA (US)

(73) Assignee: APPLE INC., Cupertino, CA (US)

(21) Appl. No.: 12/977,879

(22) Filed: Dec. 23, 2010

(51) Int. Cl. G02B 5/26; B05D 5/06

(52) U.S. Cl. 359/359; 427/161

(57) ABSTRACT

An optical coating includes multiple layers of different materials and thicknesses and is disposed proximate a transparent display cover for an electronic device display. The optical coating transmits most visible light, reflects most non-visible light and substantially absorbs blackbody radiation generated from within the electronic device. The optical coating can be readily removable from the electronic device display either alone or in combination with a removable transparent display cover. The multiple layers comprise two or more materials having alternating low and high indices of refraction, and can include 36 or more layers, each having a thickness ranging from 10 to 400 nanometers. The arrangement and thicknesses of the layers are designed based upon the thickness and optical properties of the transparent display cover.

### TECHNICAL FIELD

The present invention relates generally to computing and electronic devices, and more particularly to visual displays and presentations for such computing and electronic devices

### BACKGROUND

Personal computing and electronic devices, such as laptop computers, media players, cellular telephones, PDAs and the like are becoming ubiquitous. The ability to provide such devices in smaller and smaller sizes at affordable costs to consumers while still maintaining or increasing the power, operating speed and aesthetic appeal of such devices, has contributed greatly to this trend. Unfortunately, the trend of smaller, lighter and more powerful portable computing devices presents continuing design challenges in the actual production of these devices, particularly where such devices have relatively large display screens. Some design challenges associated with such portable electronic devices include the ability to provide clear and robust visual displays, minimize power consumption, and dissipate heat without sacrificing size, processing power or user convenience.

For example, many users like to be able to use their portable electronic devices at virtually any time, such as while the user is on the go or simply outdoors. As many consumers know, however, the use of a portable electronic device is not always ideal when the device is exposed to direct sunlight or when the ambient environment is unduly bright. For example, the relatively small size of a portable device having a powerful processing system can by itself lead to a significant amount of heat generation. As many consumers can attest, such a heated device condition can then be exacerbated by exposure to direct sunlight or being outdoors. The rapid heating or overheating of a portable electronic device in use in direct sunlight can be even further accelerated where the device has a large display screen that permits the ready passage of solar energy into the device.

Due to one or more of these and other potential factors, many portable electronic devices can be limited in being able to function fully with a robust visual display outdoors or in other environments having direct sunlight or other strong light sources. Although overall device functionality might not always be compromised, inconveniences can still arise due to increased power consumption, shorter battery life, or device overheating, among other possibilities.

While many designs and techniques used to provide computing and electronic devices have generally worked well in the past, there is always a desire to provide further improvements in such devices. In particular, what would be desirable are electronic devices that are able to provide robust functionality with respect to visual displays in sunlit or bright ambient environments while having reduced power consumption, longer battery life and improved heat dissipation.

### SUMMARY

It is an advantage of the present invention to provide visual displays for electronic device that are clearer, facilitate heat dissipation for the device, and that reduce the absorption of heat from outside the device due to direct sunlight or other infrared sources. This can be accomplished at least in part through the use of a specialized optical coating for the visual display screen. This “ART” (Absorption-Reflection-Transmission) optical coating is adapted to reflect most infrared and ultraviolet wavelengths, transmit most electromagnetic wavelengths in the visible spectrum, and absorb, distribute and radiate a significant amount of blackbody radiation from inside the device.

In various embodiments, an electronic device can include a housing adapted to contain one or more internal electronic device components therein, a processor located within the housing, at least one user interface region having one or more user interface components in communication with the processor, and a display device in communication with the processor, wherein the display device can include various items as well as a specialized ART optical coating. In some embodiments, a device display can include a visual display unit adapted to provide a visual display to a user of an electronic device associated with the electronic device display, a transparent display cover situated proximate to the visual display unit, and a specialized ART optical coating. Various further embodiments can include just the specialized ART optical coating, as well as one or more optional components, such as a transparent display cover.

In the various embodiments, the specialized ART optical coating can be disposed proximate a display cover, with the optical coating including a plurality of layers of different materials and thicknesses. The optical coating can be adapted to transmit therethrough most of all visible wavelengths of light collectively and reflect therefrom most of all non-visible wavelengths of light collectively, and can be further adapted to substantially absorb blackbody radiation generated from within an associated electronic device. In some embodiments, the optical coating can be adapted to transmit therethrough at least 80 percent of all visible wavelengths of light collectively and reflect therefrom at least 60 percent of all non-visible wavelengths of light collectively. In some embodiments, the optical coating can be adapted to transmit therethrough at least 90 percent of all visible wavelengths of light collectively and reflect therefrom at least 70 percent of all non-visible wavelengths of light collectively.

In various detailed embodiments, the optical coating is readily removable from the device display or the electronic device entirely. Such embodiments can involve the optical coating being included on a removable protective cover film having an adhesive, such as a disposable protective film. Such embodiments can also involve the optical coating being affixed to the transparent display cover such that the optical coating and transparent display cover combination is readily removable from the electronic device display. Such embodiments can involve a permanent display cover that stays with the display and overall device, as well as a removable display cover and optical coating combination. The removable combination can be a clip-on accessory or other removable and reinstallable accessory, for example.

In various detailed embodiments, the optical coating can have a plurality of layers that consists of alternating layers of two different materials, such as, for example, silicon dioxide and tantalum pentoxide. The plurality of layers can include 18 layers, 36 layers, or more layers, and the individual thicknesses of each of the plurality of layers can range from about 10 to about 400 nanometers. In some embodiments, the arrangement and thicknesses of the plurality of layers are designed based upon the thickness and optical properties of the transparent display cover.

Various further embodiments can include a selectively transmissive optical system having a transparent panel having a first surface and second surface, a first plurality of optically transmissive layers, each formed from the same first material having a first index of refraction, and a second plurality of optically transmissive layers, each formed from the same second material having a second index of refraction. The second plurality of optically transmissive layers is interleaved with the first plurality of optically transmissive layers to form a collective optical coating that is situated proximate to the first surface of the transparent panel. As in the foregoing embodiments, the optical coating is adapted to transmit therethrough at least 90 percent of all visible wavelengths of light collectively, to reflect therefrom at least 80 percent of all non-visible wavelengths of light collectively, and to absorb substantially blackbody radiation generated from beyond the second surface of the transparent panel. The optical coating can also be readily removable from the transparent panel.

In various additional embodiments, a method for forming a display cover for an electronic device can include the steps of determining the thickness and optical properties of a transparent display cover adapted to be situated proximate to a visual display unit of an electronic device, designing an optical coating adapted to be disposed proximate the transparent display cover, and creating the optical coating in a manner such that the optical coating is readily removable from the electronic device display. Again, the optical coating can have a plurality of layers of different materials and thicknesses, wherein said optical coating is adapted to transmit therethrough at least 90 percent of all visible wavelengths of light collectively and reflect therefrom at least 80 percent of all non-visible wavelengths of light collectively.

Other apparatuses, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and arrangements for the disclosed inventive apparatuses and methods for providing improved optical displays on electronic devices. These drawings in no way limit any changes in form and detail that may be made to the invention by one skilled in the art without departing from the spirit and scope of the invention.

FIG. 1 illustrates in top perspective view an exemplary portable electronic device according to one embodiment of the present invention.

FIG. 2 illustrates in front facing perspective view another exemplary portable electronic device according to one embodiment of the present invention.

FIG. 3 illustrates in side perspective and partially exploded view the exemplary portable electronic device of FIG. 2 according to one embodiment of the present invention.

FIG. 4A illustrates in partial side cross-sectional view an exemplary ART optical coating for an electronic device according to one embodiment of the present invention.

FIG. 4B illustrates in partial side cross-sectional view the exemplary optical coating of FIG. 4A as transmitting a visible light wavelength and reflecting an infrared light wavelength according to one embodiment of the present invention.

FIG. 5A illustrates a graph of the ideal amount of passed and reflected light wavelengths for an ideal optical coating application.

FIG. 5B illustrates a graph of the amount of passed and reflected light wavelengths for a typical hot mirror.

FIG. 5C illustrates a graph of the amount of passed and reflected light wavelengths for an exemplary specialized ART optical coating according to one embodiment of the present invention.

FIG. 6 illustrates in table format two exemplary formulae for creating ART optical coatings according to one embodiment of the present invention.

FIG. 7 provides a table of overall targets and results of an ART optical coating for an electronic device according to one embodiment of the present invention.

FIG. 8 illustrates in partial side cross-sectional view an exemplary application of an ART optical coating for an electronic device according to one embodiment of the present invention.

FIG. 9 provides a flowchart of an exemplary method of improving a display for an electronic device according to one embodiment of the present invention.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention. Although this disclosure primarily focuses on portable electronic devices for purposes of illustration and discussion, it will be readily appreciated that the present invention is not limited to such devices, and that the present invention can be used in conjunction with any computing device or item having a visual display.

The invention relates in various embodiments to an optical coating for a visual display. The optical coating can be specially formulated to block out unwanted solar energy, transmit visible light, and absorb blackbody radiation. This optical coating can be applied directly to a display cover glass or product skin, or can be applied indirectly via an accessory designed to interact with a visual display. Multiple different types of applications of such an optical coating can also be used in some instances.

### ART Coating

In general, the “ART” (Absorption-Reflection-Transmission) optical coating can be a thin overall coating that is made up of many alternating layers of thin materials having both high and low refractive indices, arranged in such a manner so as to: A-absorb blackbody radiation from inside the device to promote better device cooling; R-reflect most of all electromagnetic wavelengths that are not visible light to reduce device heating from outside sources; and T-transmit most of all visible light wavelengths to enable robust visual displays. In general, the optical coating operates such that the unwanted infrared and ultraviolet radiation from the sun is reflected back to the ambient environment as much as possible. This does not appear as glare to the user as these wavelengths are visible. Visible light transmitted through the optical coating as much as possible, so as not to interfere with the appearance and brightness of the intended visual image of the display. The coating also absorbs the black body infrared radiation range emitted by the device as much as possible.

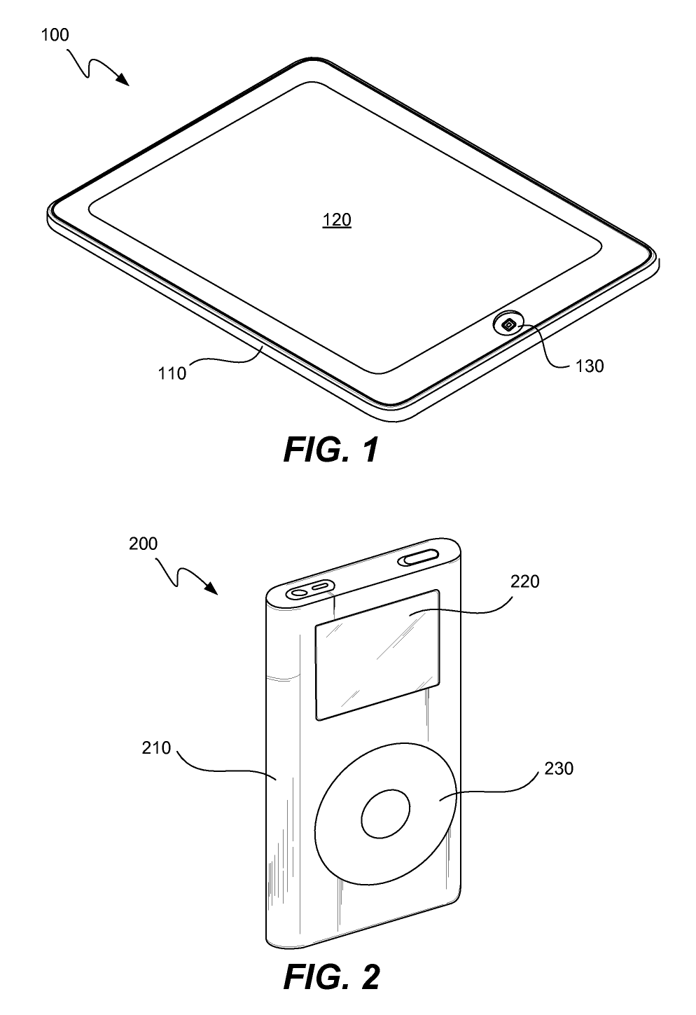

Turning first to FIG. 1, an exemplary portable electronic device according to one embodiment of the present invention is illustrated in top perspective view. Portable electronic device 100 can be, for example, a tablet computing device, and can include an outer housing 110, a display screen 120, and one or more buttons 130 or other user inputs. Such a tablet portable electronic device 100 can be, for example, an iPad® computing device manufactured and sold by Apple, Inc. of Cupertino, Calif., although many other types of devices may also be used. Although portable electronic device 100 can appear to be exactly like any other similar portable electronic device, it can be different due to the presence of the inventive specialized optical coating being located proximate the visual display or display cover, as set forth in greater detail below.

FIG. 2 illustrates in front facing perspective view another exemplary portable electronic device according to one embodiment of the present invention. Portable electronic device 200 can be, for example, a portable media player having an outer housing 210, a display screen 220 and a click-wheel 230 or other user input. Such a portable media player can be, for example, an iPod® computing device, also manufactured and sold by Apple, although many other types of media player devices may also be used. Again, device 200 can appear to be the same as other similar devices, despite the presence of a specialized ART optical coating proximate the visual display.

In fact, virtually any device having a display screen can be suitable for use with the present invention, as will be readily appreciated by those skilled in the art. As such, the exemplary devices 100, 200 provided in FIGS. 1 and 2 serve only to illustrate examples of such devices, and in no way limit the amount or types of devices that can be used. Other types of devices that may also be used with the inventive optical display coating can include, for example, cellular telephones, pagers, laptop computers, desktop computers, televisions, and wristwatches among other possible devices.

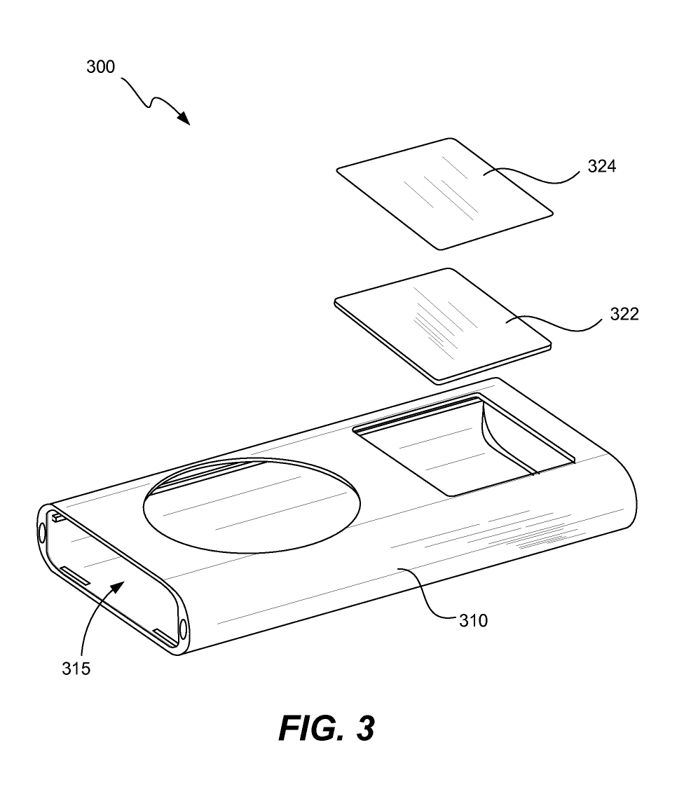

Continuing with FIG. 3, the portable electronic device of FIG. 2 is shown in side perspective and partially exploded view. Again, although virtually any type of device having a display screen can be used in conjunction with the present invention, portable electronic device 300 is being used here simply for purposes of illustration with respect to the display screen and its specialized optical coating. Variations and extrapolations suitable for use with devices having different display screen types, sizes and dimensions can be applied as may be desired for any device having a display screen, as will be readily appreciated.

Portable electronic device 300 can include an outer housing 310 having an interior cavity 315 adapted to contain various internal electronic components (not shown), such as a processor, memory, display device, speakers and the like. A transparent display cover 322 can be situated in an opening in the housing 310 that is specifically dimensioned to hold the display cover in place. The display cover 322 can be designed to protect a video or visual display (not shown) situated therebeneath, and is preferably see-through. Although the display cover 322 can be purely transparent, a partially transparent or translucent display cover may also be used, and it will be understood that all such variations can be considered “transparent” for purposes of the disclosed devices and displays. A specialized optical coating 324 can be situated atop the display cover 322, with details and properties of this optical coating being set forth in greater detail below. Although optical coating 324 is shown as being atop display cover 322, the actual location can be beneath or otherwise proximate the display cover, depending upon the given application.

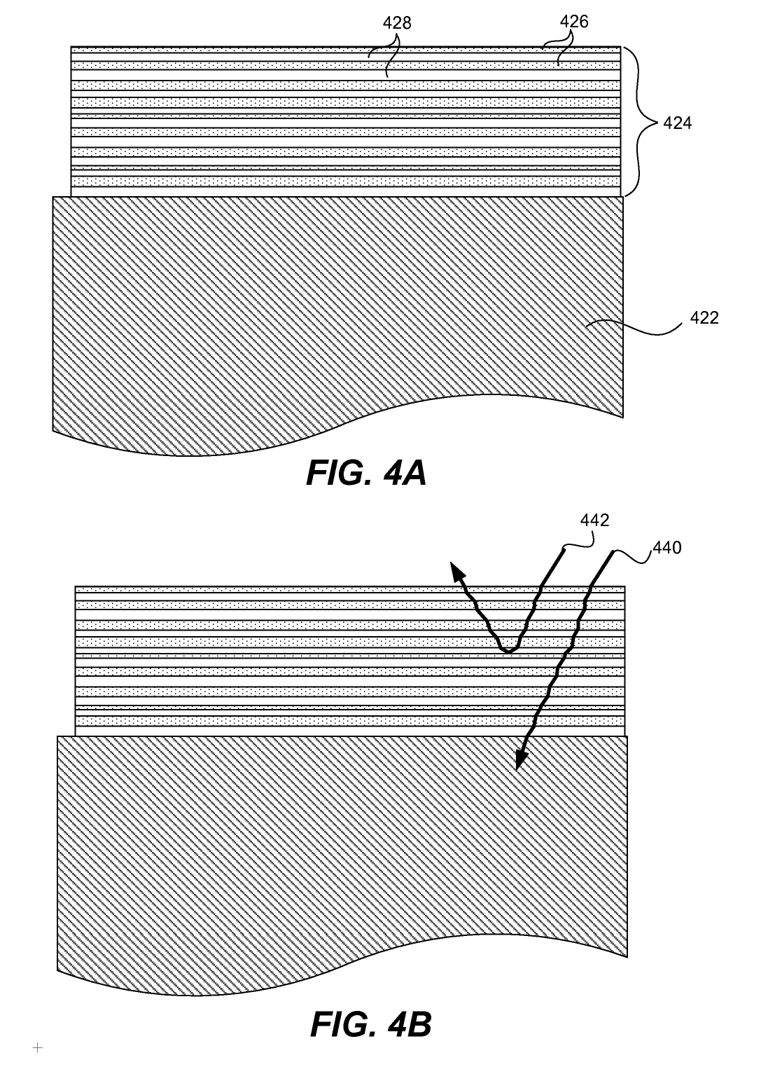

Moving now to FIG. 4A, an exemplary specialized ART optical coating for an electronic device according to one embodiment of the present invention is shown in partial side cross-sectional view. As shown, optical coating 424 can be situated atop or otherwise proximate to a display cover 422 for a visual display (not shown). Such a visual display can be for an electronic device, among other possible devices. Optical coating 424 can be comprised of numerous thin layers, ranging in thickness from about 10 to about 400 nanometers, although other thicknesses are possible. Each layer can be comprised of a material having a high or low index of refraction, and the layers are preferably interleaved or alternated between high and low indices of refraction. Preferably, desirable wavelengths of light are transmitted through optical coating 424, while unwanted wavelengths are reflected away from the optical coating, similar to that which occurs for a “hot mirror.” In addition, the various layers and thicknesses of optical coating 424 are designed such that most blackbody radiation is neither transmitted nor reflected, but rather absorbed by and transmitted throughout the optical coating itself.

Although more than two different materials can certainly be used, as may be desired, only two different materials for the various layers are shown here for purposes of illustration. As shown, a first set of layers 426 is composed of a first material having one index of refraction, while a second set of layers 428 is composed of a second different material having a different index of refraction. In one particular non-limiting example, the two different materials can be silicon dioxide and tantalum pentoxide, having indices of refraction of about 1.45 and 2.10 respectively. Again, layers of other materials can be added to or substituted for these particular materials, so long as there is a significant difference between layers in the indices of refraction.

FIG. 4B illustrates this phenomenon of the exemplary optical coating of FIG. 4A as transmitting a visible light wavelength and reflecting an infrared light wavelength. As shown, visible light wavelength 440 incumbent upon the optical coating and display cover combination is permitted to transmit through both of these items. Although the alternating indices of refraction of the various optical coating layers does alter the path of wavelength 440 a bit, the wavelength is ultimately transmitted all the way therethrough, as are other visible light wavelengths. As will be appreciated, similar light wavelengths from the display located beneath the cover glass will transmit upward and through the cover glass and optical coating, and will then be visible to users of the electronic device having the display. Conversely, infrared wavelength 442 is ultimately reflected back away from the display cover due to the arrangement of layers in the optical coating, which prevents the infrared wavelength from entering and heating the device through the display cover. Similar results preferably occur for other infrared wavelengths.

Although a typical hot mirror generally transmits many desirable wavelengths of light and reflects many undesirable wavelengths of light, a hot mirror tends to be imperfect in nature and unsuitable for use with a portable electronic device. This is because the general intent for a hot mirror is simply to reflect most infrared radiation, without due care for a high quality transmittance of a video display or substantially all infrared and ultraviolet wavelengths. As such, many hot mirrors are tinted in nature and have only a few alternating layers of material.

In contrast, the optical coating disclosed herein is specifically designed to transmit as much visible light as possible and to reflect as much non-visible light as possible. Such a specific result requires the use of many layers of precisely controlled thicknesses, specified according to a formula that is known to control light in the manner desired. This is done through refining the layers and thicknesses until substantially all or most all desirable wavelengths are transmitted, while substantially all or most all undesirable wavelengths are reflected. In some embodiments, the specialized optical coating disclosed herein can include at least 18 different thin layers, again alternating between low and high indices of refraction. In further embodiments, at least 36 different thin layers can be used. Even more layers can be used, where further maximization of light manipulation is desired.

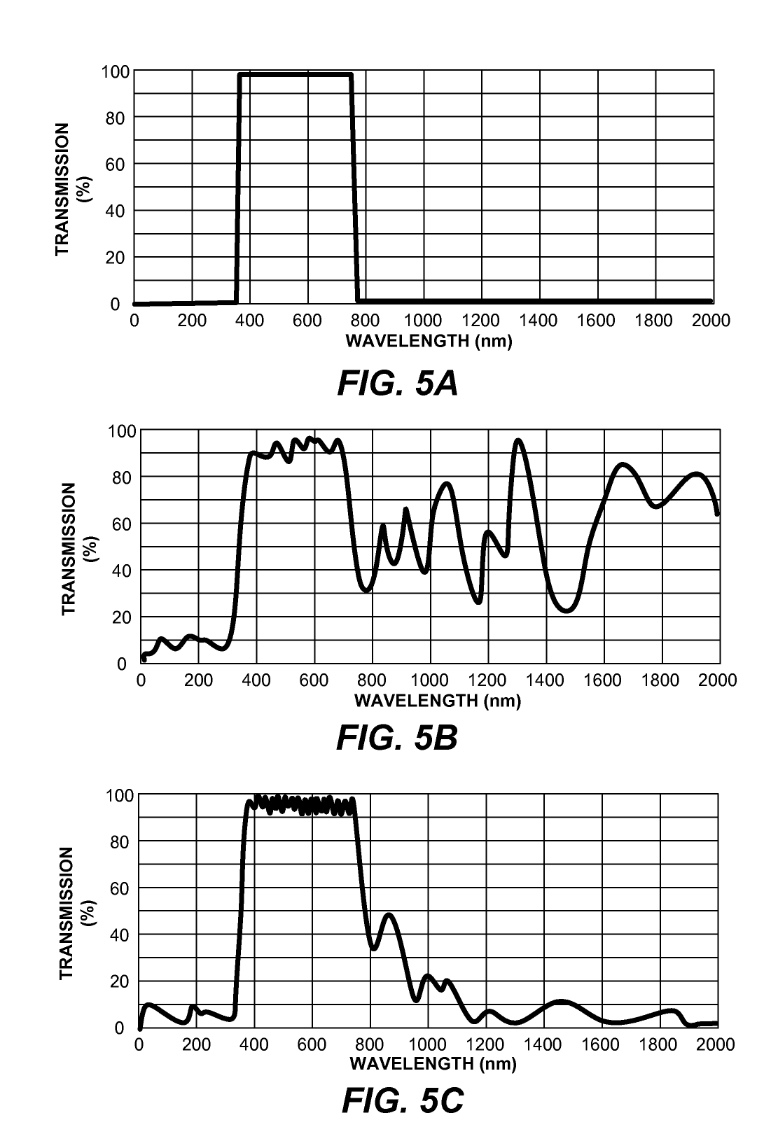

Continuing with FIGS. 5A through 5C, various graphs of the amounts of transmitted light by wavelength are provided. FIG. 5A illustrates a graph of the ideal amount of passed and reflected light wavelengths for the given application. FIG. 5B then illustrates a graph of the amount of passed and reflected light wavelengths for a typical hot mirror, while FIG. 5C illustrates a graph of the amount of passed and reflected light wavelengths for an exemplary specialized ART optical coating according to one embodiment of the present invention. As shown in FIG. 5A, an ideal application would result in all visible wavelengths being transmitted at 100%, while all non-visible wavelengths (i.e., ultraviolet and infrared) being transmitted at 0% (i.e. reflected or absorbed).

Results from a typical hot mirror are reflected in FIG. 5B, which shows that while much visible light is transmitted and a lot of non-visible light is not transmitted, the results are far from ideal. FIG. 5C indicates improved results, however, from an optical coating that has been refined considerably. In particular, additional layers have been added to retain transmittance of as much visible light as possible, while even further layers are added to reflect as much infrared light as possible. The end results are a display cover and optical coating combination that transmits clearly visual images therethrough to a user while allowing very little ultraviolet and infrared energy into the device via the display screen. This is particularly useful in reducing device heating in outdoor and direct sunlight conditions.

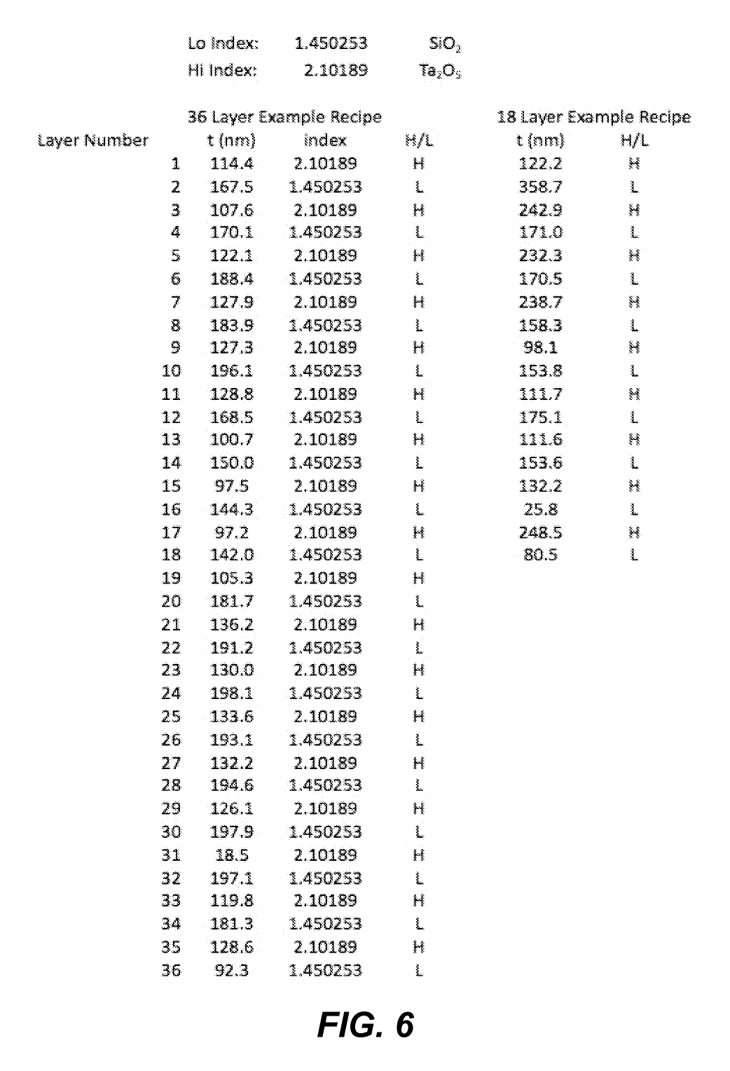

FIG. 6 illustrates in table format two exemplary formulae or “recipes” for creating ART optical coatings according to one embodiment of the present invention. These particular formulae are exemplary and non-limiting in nature, as it will be readily understood that other materials may be used, more or fewer layers may be used, and different thicknesses and alternating patterns may be used with similar or even improved results, as may be discovered through trial and error or various modeling programs. Even better results may be observed by using more layers, such that 50 or 100 layers or more may be use for a given application. Of course, greater costs and overall coating thicknesses will then arise.

One factor that should not be overlooked in the use of a specific optical coating formula, such as those set forth in FIG. 6, is that the composition, thickness and optical properties of the display cover and/or display device components must also be taken into account. That is, the paths of light for various light frequencies will also be altered by the display cover and any other optical components outside the display device itself. As such, the overall optical coating specifications must be customized to include such components. For example, a specialized optical coating as set forth above with respect to device 200 may not work well with device 100, due to differences in the display devices and display covers for these different devices. Accordingly, the thicknesses and optical properties of any base display device and display cover must be determined as part of an optical coating formulation or recipe creating process. As a particular example, the specific recipes set forth above in FIG. 6 have been optimized to work with a display cover having a thickness of 0.6 mm and a refractive index of 1.5.

As shown in FIG. 5C, results from the particular optical coating measured results in a transmittance therethrough of about 90 percent of all visible wavelengths of light collectively and a reflectance therefrom of about 70 percent of all non-visible wavelengths of light collectively. This is the result of the specific 36 layer recipe set forth in FIG. 6. Similar results can be had as the result of the specific 18 layer recipe also set forth in FIG. 6, although this result has a transmission that is somewhat lower and a reflectance of non-visible light that is somewhat lower than for the 36 layer recipe. Again, the use of additional layers can result in even better percentages, where desired.

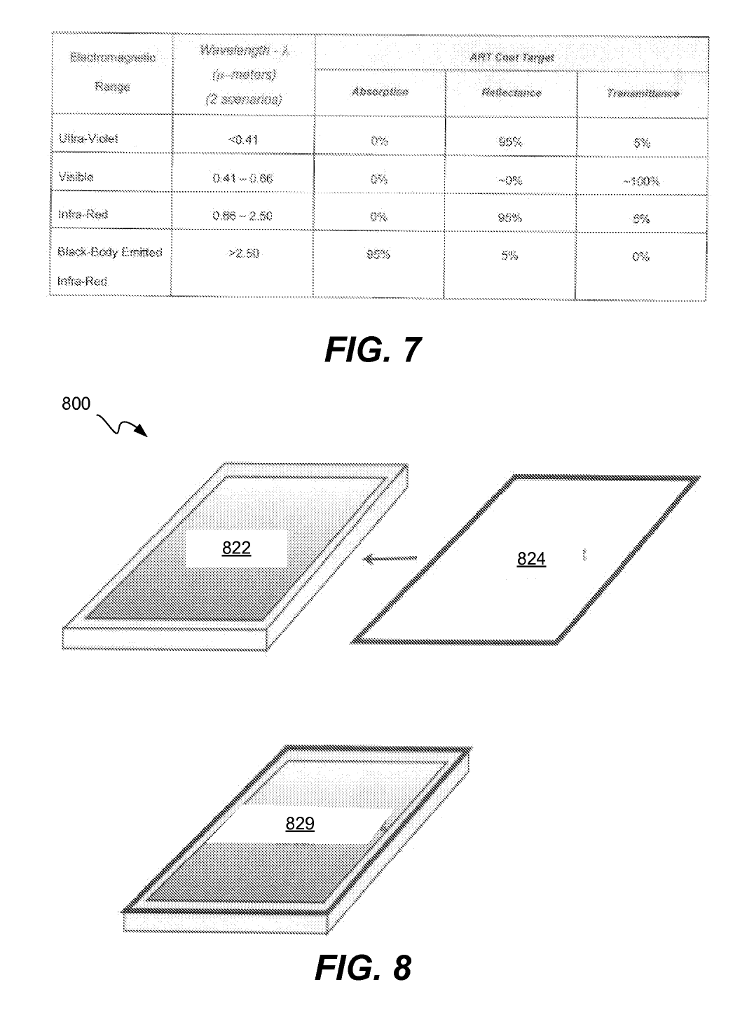

Another result of the particular formulae shown in FIG. 6 is that most blackbody radiation (e.g., above 2500 nm) is absorbed by and distributed throughout the optical coating. In some embodiments, about 95% of the blackbody radiation generated by the host electronic device can be absorbed by the specialized optical coating, which helps substantially in heat dissipation for the overall device. These are set forth in FIG. 7, which depicts overall targets and results of an ART optical coating for an electronic device according to one embodiment of the present invention.

### Applications

It will be readily appreciated that the refined and specialized optical coating and devices to which it is applied provide clear improvements and benefits over previous devices for which device overheating can be an issue. One notable application is simply the permanent application of an optical coating to a display cover or cover glass during the manufacturing of a device. Such a permanent application can be atop, inside or at the bottom of the display cover, as may be desired by a given manufacturer. In addition to a simple permanent application of an optical coating to an existing device though, there are further applications that may prove useful to consumers.

Turning now to FIG. 8, one exemplary application of an ART optical coating for an electronic device according to one embodiment of the present invention. Electronic device 800 can include a relatively large display, over which a display cover 822 is located. A removable optical coating 824 can be applied to device 800 such that a resulting display cover and coating combination 829 is created. The resulting combination 829 by using a removable and/or replaceable optical coating 824 is preferably identical or substantially similar in results to a permanent application of an optical coating.

There are several ways in which a removable optical coating 824 may be used in conjunction with a suitable electronic device 800. For example, a clip-on screen saver type accessory may be specifically designed for device 800. Such an accessory may be dimensioned to match the size of device 800, and may also include clips, pins, magnets, or other suitable removable attachment means that allow the clip-on removable device to attach to the overall electronic device while the user so desires such an attachment. An optical coating 824 can be built into the clip-on device and designed in such a way so as to be contacting or otherwise proximate to the display cover 822 of the overall device 800. Such a clip-on type device can be useful where one decides to use a specialized optical coating screen protection while outdoors or in direct sunlight, but not while indoors or in other circumstances.

Another example of a removable optical coating can be one that is implemented in a disposable screen protection type product. For example, many portable electronic devices have large touchscreen type displays that some users find useful to protect by way of disposable thin touchscreen protectors. Such touchscreen protectors are commonly used on the iPhone®, for example, and are typically formed from a strong scratch resistant plastic material as a film with an adhesive on one side. Such a touchscreen protector can also be formed to include a specialized optical coating as disclosed above, albeit customized not only for the device display cover, but also for the thickness and optical properties of the protective plastic film itself.

One advantage of having the optical coating being removable is that a user may decide to change optical coatings or vehicles therefor, such as where higher quality or a lower price may be desired. For example, a cheaper 18 layer version of the optical coating and a more expensive 50 layer version of the optical coating may be offered in a removable setting, such as a clip-on or a touchscreen protective film and adhesive type application. When a user removes and disposes of a lower quality but cheaper 18 layer version coating, the user may decide to replace it with a higher quality 50 layer version of the coating in a new touchscreen protective film, for example. Various other removable applications of optical coatings, in the form of sleeves, films, covers and the like can also be implemented as may be suitable, and it will be understood that all such applications of removable specialized optical coatings are contemplated for use with the present invention.

### Methods

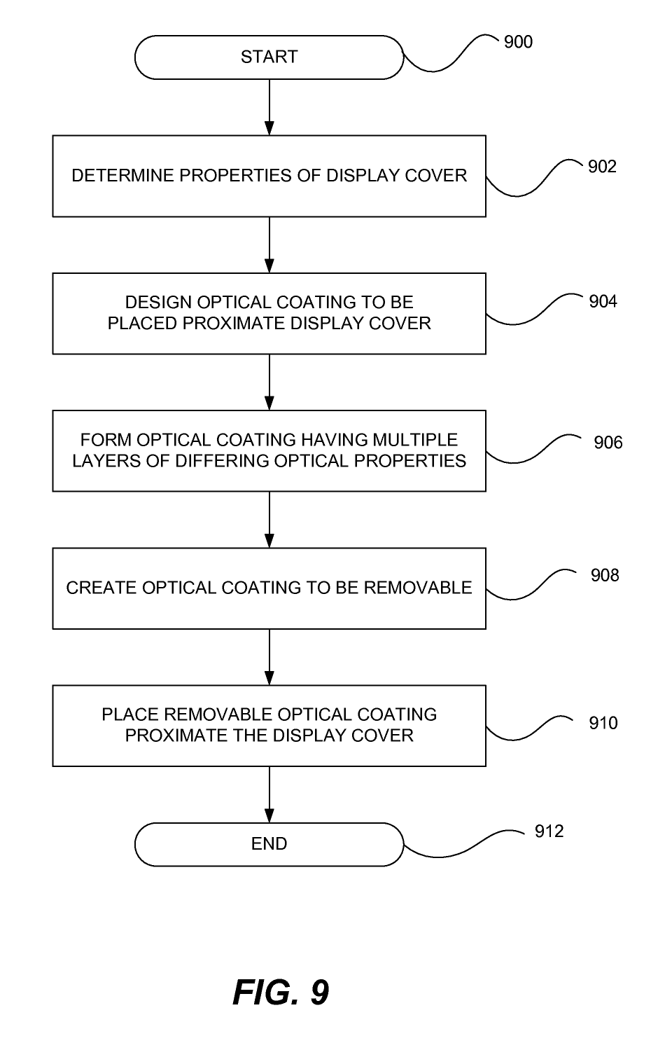

Moving lastly to FIG. 9, a flowchart of an exemplary method of improving a display for an electronic device is provided. Such an improvement can involve the creation or use an ART optical coating for the display. It will be understood that the provided steps are shown only for purposes of illustration, and that many other steps may be included in the process, as may be desired. Furthermore, the order of steps may be changed where appropriate and not all steps need be performed in various instances. After a start step 900, the optical properties of a display cover for an electronic device are determined at a process step 902. This can involve determining the thickness and index of refraction of the display cover, and also any other pertinent component of the display itself, for example.

At a following process step 904, an optical coating is specially designed to take into account the determined properties, such that substantially all or most visible light is transmitted therethrough, while substantially all or most non-visible light is reflected therefrom, as discussed in greater detail above. The optical coating is then formed at process step 906, after which the optical coating is created into a form or put into a vehicle that is removable from the host electronic device at process step 908. An optional subsequent process step 910 can involve actually placing the removable optical coating proximate the display cover, although this step may not always be necessary. The method then ends at end step 912.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. An electronic device display, comprising:
a visual display unit adapted to provide a visual display to a user of an electronic device associated with the electronic device display;
a transparent display cover situated proximate to the visual display unit; and
an optical coating disposed proximate said display cover, said optical coating including a plurality of layers of different materials and thicknesses, wherein said optical coating is adapted to transmit therethrough most of all visible wavelengths of light collectively, reflect therefrom most of all non-visible wavelengths of light collectively, and to absorb most blackbody radiation generated from within the electronic device.

2. The electronic device display of claim 1, wherein said optical coating is readily removable from the electronic device display.

3. The electronic device display of claim 2, wherein said optical coating is affixed to said transparent display cover and the optical coating and transparent display cover combination is readily removable from the electronic device display.

4. The electronic device display of claim 1, wherein said optical coating is adapted to transmit therethrough at least 80 percent of all visible wavelengths of light collectively and reflect therefrom at least 60 percent of all non-visible wavelengths of light collectively.

5. The electronic device display of claim 1, wherein said optical coating is adapted to transmit therethrough at least 90 percent of all visible wavelengths of light collectively and reflect therefrom at least 70 percent of all non-visible wavelengths of light collectively.

6. The electronic device display of claim 1, wherein said plurality of layers consists of alternating layers of two different materials.

7. The electronic device display of claim 6, wherein said two different materials are silicon dioxide and tantalum pentoxide.

8. The electronic device display of claim 7, wherein said plurality of layers comprises at least 36 layers.

9. The electronic device display of claim 1, wherein the individual thicknesses of each of said plurality of layers are between about 10 and about 400 nanometers.

10. The electronic device display of claim 1, wherein the arrangement and thicknesses of said plurality of layers are designed based upon the thickness and optical properties of the transparent display cover.

11. An electronic device, comprising:
a housing adapted to contain one or more internal electronic device components therein;
a processor located within said housing;
at least one user interface region having one or more user interface components in communication with said processor; and
a display device in communication with said processor and having:
a visual display unit adapted to provide a visual display to a user of the electronic device;
a transparent display cover situated proximate to the visual display unit; and
an optical coating disposed proximate said display cover, said optical coating including a plurality of layers of different materials and thicknesses, wherein said optical coating is adapted to transmit therethrough most of all visible wavelengths of light collectively and reflect therefrom most of all non-visible wavelengths of light collectively, and wherein said optical coating is readily removable from the electronic device.

12. The electronic device of claim 11, wherein said removable optical coating is included on a removable protective cover film having an adhesive.

13. The electronic device of claim 11, wherein said optical coating is adapted to transmit therethrough at least 80 percent of all visible wavelengths of light collectively and reflect therefrom at least 60 percent of all non-visible wavelengths of light collectively.

14. The electronic device of claim 11, wherein said optical coating is further adapted to absorb substantially blackbody radiation generated from within the electronic device.

15. The electronic device of claim 11, wherein the arrangement and thicknesses of said plurality of layers are designed based upon the thickness and optical properties of the display cover.

16. A selectively transmissive optical system, comprising:
a transparent panel having a first surface and second surface;
a first plurality of optically transmissive layers, each formed from the same first material having a first index of refraction; and
a second plurality of optically transmissive layers, each formed from the same second material having a second index of refraction,
wherein the second plurality of optically transmissive layers is interleaved with the first plurality of optically transmissive layers to form a collective optical coating that is situated proximate to the first surface of the transparent panel,
wherein said optical coating is adapted to transmit therethrough most of all visible wavelengths of light collectively, to reflect therefrom most of all non-visible wavelengths of light collectively, and to absorb substantially blackbody radiation generated from beyond the second surface of the transparent panel, and
wherein said optical coating is readily removable from the transparent panel.

17. The selectively transmissive optical system of claim 16, wherein said first plurality of layers comprises at least 18 layers and said second plurality of layers comprises at least 18 layers.

18. The selectively transmissive optical system of claim 16, wherein the thicknesses of said first and second plurality of layers are designed based upon the thickness and optical properties of the transparent panel.

19. The selectively transmissive optical system of claim 16, wherein said first material is silicon dioxide and said second material is tantalum pentoxide.

20. A method for improving a display of an electronic device, comprising:
determining the thickness and optical properties of a display cover adapted to be situated proximate to a visual display unit of an electronic device;
designing an optical coating adapted to be placed proximate the display cover, said optical coating including a plurality of layers of different materials and thicknesses, wherein said optical coating is adapted to transmit therethrough most of all visible wavelengths of light collectively and reflect therefrom most of all non-visible wavelengths of light collectively;
forming the optical coating having the plurality of layers of differing optical properties; and
creating the optical coating in a manner such that the optical coating is readily removable from the electronic device display.

21. The method of claim 20, wherein the optical coating is included on a removable protective cover film having an adhesive.

22. The method of claim 20, wherein the optical coating is affixed to the transparent display cover and the optical coating and transparent display cover combination is readily removable from the electronic device display.

23. The method of claim 20, further including the step of:
placing the removable optical coating proximate the display cover.
